(19) United States
(12) Patent Application Publication
(10) Pub. No.: US 2002/0095327 A1
(43) Pub. Date: Jul. 18, 2002

(54) Method and apparatus for automated demand trend correction during dynamic pricing

(76) Inventors: Nina Barrameda Zumel, San Francisco, CA (US); Vladimir Gorelik, Palo Alto, CA (US)

Correspondence Address: Brian D. Hickman, HICKMAN PALERMO TRUONG & BECKER LLP, 1600 Willow Street, San Jose, CA, 95125-5106, US

(21) Appl. No.: 09/726,725

(22) Filed: Nov. 29, 2000

(51) Int. Cl. G06F 17/60

(52) U.S. Cl. 705/10

(57) ABSTRACT

Techniques are described for automated dynamic pricing of a product according to the demand trend for the product and by isolating the effect of price on the demand for the product. Price candidates for a product are either offered in parallel or in series to determine an optimal price. The offering of price candidates accounts for market trends that affect the optimal price for a product. Once an optimal price is offered for a product, the optimal price is monitored using an automated monitor process. During the automated monitor process, periodic demand measurements (L2B measurements) are taken for the optimal price. If there is a significant change in demand, the monitor process will trigger a re-offering of price candidates to determine a new optimal price.

### FIELD OF THE INVENTION

The present invention relates generally to pricing and, more specifically, to automatically correcting to compensate for the demand trend during dynamic pricing of a product or pricing unit.

### BACKGROUND OF THE INVENTION

Electronic commerce websites enable a business to sell products and services to consumers and other businesses. For a particular product, the pricing that is displayed on an electronic commerce website is controlled by one or more product merchandiser. Product merchandisers price items based on the merchandiser's knowledge of the product, of the market demand for the product in different customer segments, business strategies and policies, and of competing products. For example, in the apparel business, there may be a product merchandiser who specializes in men's shoes. In order to set a price for an item, the merchandiser will qualitatively evaluate the market and factors such as: the product itself, the brand strength, market conditions, business goals, seasons, past sales etc. From a microeconomics point of view, the merchandiser is making an educated prediction of shape of the demand curve, and thereby guessing the optimal price for the product.

The merchandiser is required to make frequent analysis of the market conditions and predict the demand related to a product and manually adjust the price accordingly. Thus, the price of a product may not be adjusted frequently enough to capture either large or small market trends. Moreover, as the number of items that need to be priced grows, and the business rules for determining prices become more complex, the manual pricing model becomes unwieldy and intractable.

More empirical price determination approaches have been developed in which a product is sold at a first price for a first trial period, and then sold at a second price for a second trial period. A determination is then made about which price is “better” based on a variety of factors, including how many sales were made during each of the two time periods. One deficiency of this approach is that it ignores demand trends. For example, more sales may have occurred during the second trial period simply because the particular product had become more popular, rather than as a reaction to the price change.

Based on the foregoing, there is clear need for a mechanism for correcting the demand trend during price calibration of a product.

### SUMMARY OF THE INVENTION

Techniques are provided to counteract the effect of market trends when performing comparisons between price candidates, thereby allowing a more accurate determination of the effect of price on the demand for a pricing unit. According to one embodiment, the techniques are employed during an automated calibration operation of price candidates for the pricing unit in an electronic commerce environment.

According to one aspect of the invention, the same product or price unit is offered at different prices to different customers in the electronic commerce environment. The prices for which the price unit is offered are referred to herein as “price candidates”. Demand for the price candidates is measured. To counteract the effect of market trends, the price candidates are offered in parallel, during the same time interval, or during interleaved time intervals.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a system overview of certain embodiments of the invention;

FIG. 2 is a graph that illustrates a hypothetical binomial distribution curve;

FIG. 3 is a graph that illustrates a confidence value;

FIGS. 4A, 4B, 4C illustrate a series of probability distributions for demand;

FIGS. 5A, 5B, 5C, 5D, 5E are flowcharts that illustrate a method of parallel offering;

FIGS. 6A, 6B, 6C, 6D, 6E, 6F, 6G, 6H are flowcharts that illustrate the serial offering operation;

FIG. 7 is a flowchart that illustrates the monitor operation; and

FIG. 8 depicts a computer upon which embodiments of the invention may be implemented.

### DETAILED DESCRIPTION OF THE PREFERRED EMBODIMENT

Techniques are provided for an automated process for correcting the demand trend during price offering for a product. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### FUNCTIONAL OVERVIEW

According to certain embodiments of the invention, several price candidates are offered in parallel (“parallel offering”). In one embodiment, the parallel offering operation includes publishing information about the price candidates online during the same time interval, and taking periodic demand measurements for each price candidate.

According to one embodiment, a demand measurement, also referred to herein as a “L2B measurement” is made based on the ratio of the number of “buys” to the number of “looks” corresponding to each price candidate. A probabilistic estimation of demand is determined for each demand measurement. The probabilistic estimation of demand may vary from implementation to implementation. In certain embodiments, the probabilistic estimation of demand may be a probability distribution of demand. From the probability distribution, an expected demand corresponding to the price candidate can be determined. A price candidate is said to have converged when the confidence in the expected demand corresponding to the price candidate has reached a pre-selected confidence value.

A price candidate that has converged is herein referred to as a “converged” price candidate. The first price candidate to converge is used as a baseline price against which other candidate prices in the parallel offering are compared. A price candidate that underperforms the baseline price is rejected and is replaced with a new price candidate.

The new price candidate is offered in parallel with the other price candidates that are still being offered. A price candidate that outperforms the baseline price will replace the baseline price as the new baseline price against which other price candidates are compared. A baseline price that is replaced in this manner is rejected (removed from the parallel offering) and a new price candidate is brought into the parallel offering. Each time a new price candidate is brought into the parallel offering, the probability distribution of demand for all the price candidates in the parallel offering, including the baseline price, is updated and parallel offering resumes. In certain embodiments of the invention, the probability distribution is updated using a window averaging for each ordinate value of the distribution curve.

In certain embodiments of the invention, price candidates are offered one at a time (“serial offering”). Instead of calibrating a price candidate straight through until convergence is reached, the price candidate is offered until a pre-selected condition is satisfied. After the pre-selected condition is satisfied, another price candidate is offered. This process of switching back and forth between price candidates may be repeated any number of times such that the time intervals during which one price candidate is offered are interleaved with the time intervals during which another price candidate is offered.

For example, a price candidate may be offered until a threshold of demand value is reached. When the pre-determined threshold is reached, the price candidate is marked as “pending”. Offering of that price candidate is temporarily halted and a second price candidate is brought in for serial offering.

Offering of the second price candidate continues until the second price candidate may be marked as “pending”. Once there is a pair of pending price candidates, one of the pending price candidates is selected for serial offering until convergence. The converged price candidate is used as a baseline price, and the other pending price candidate in the pair of pending price candidates is offered against the baseline price. If the pending price candidate outperforms the baseline price, then the baseline price will be rejected and the pending price candidate emerges as the “surviving baseline price”. However, if the pending price candidate underperforms the baseline price, then the pending price candidate is rejected and the baseline price is the surviving baseline price. The probability distribution of demand corresponding to the surviving baseline price is reset and the serial offering operation as described herein, starts over again. The serial offering is repeated until no more price candidates remain to be offered. The last surviving baseline price becomes the current price for the pricing unit.

An automated monitor operation monitors the current price. If it is determined that the there is a significant shift in the demand trend, the monitor operation may trigger a restart of the offering operation.

### SYSTEM OVERVIEW

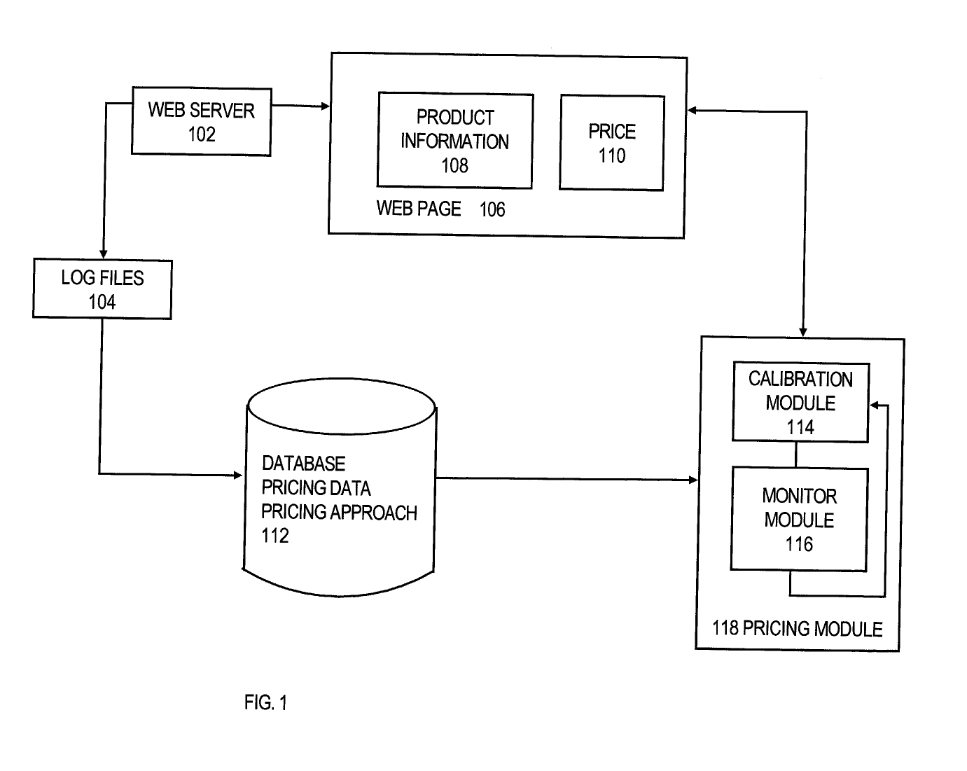

FIG. 1 is a block diagram that illustrates a system overview of certain embodiments of the invention. In FIG. 1, system 100 comprises web server 102 that is coupled to a database 112 through log files 104 that are produced by web server 102. Web server 102 generates a web page 106 in response to a request for a web page from a client (not shown in FIG. 1). Web page 106 is interconnected to pricing module 118.

An electronic vendor may use web server 102 to advertise the vendor's products on web page 106. For example, web page 106 may contain product information 108, and specify a price 110 of the product item. For example, product information 108 may include textual description of the product, digital photographs or computer graphic illustrations of the product item.

In certain embodiments of the invention, product information 108 and price 110 are associated with a specific “pricing unit”. A pricing unit takes into account not only the product or service offered, but also one or more other factors. Such other factors may include, for example, a customer segment and seasonality.

For example, a product item, Acme Umbrella Model No. B, may have several associated pricing units. There may be a pricing unit for Acme Umbrella Model No. B for customers in the North Western U.S. during the summer rainy season, and there may be a separate pricing unit for Acme Umbrella Model No. B for customers in the South Eastern U.S. during the winter season. Thus, price 110 may vary for different pricing units associated with the same product item.

Web server 102 may generate log files 104. Log files 104 may include information on customers that access web page 106. Customer information may include transaction logs of completed purchases that were made using web server 102. In certain embodiments of the invention, log files include information on the number “window shopping” occurrences (instances in which customers look at the web page 106 advertising the product) during a specified time interval. The number of completed purchases are herein referred to as the “number of buys”, and the corresponding “window shopping” occurrences are herein referred to as “number of looks”.

In certain embodiments, log files 104 are periodically transmitted to database 112 for storage. Pricing module 118 comprises calibration module 114 and monitor module 116. Calibration module 114 offers candidate prices for the pricing unit. Monitor module 116 monitors the demand corresponding to a current price for the pricing unit. Pricing module 118 dynamically determines the price for a pricing unit according to analysis of data in database 112 and a vendor-selected pricing model. A vendor-selected pricing model for a pricing unit may include using a “goal function”, f. In economic theory, a goal function expresses the value of selling various quantities of the product item. A goal function may involve one or more attributes of a product item, which attributes include but are not limited to the following: shipping costs, discounts on the product, product bundling, product features, revenue, or profit. The present invention is not limited to any specific goal function. The goal function may vary from implementation to implementation. For the purpose of illustration, a goal function for revenue or profit is as shown below:

f ᵣₑᵥₑₙᵤₑ(price of pricing unit)=(price of pricing unit) (number of items of the pricing unit sold)

f _{profit}(price of pricing unit)=(price of pricing unit−cost of pricing unit) (number of items of the pricing unit sold)

Revenue is price of the pricing unit multiplied by the number of items of the pricing unit sold. Profit is price less cost multiplied by the number of items of the pricing unit sold.

For a given pricing unit, a goal function has a maximum value for a given interval pricing values. Pricing module 118 may be used to dynamically determine the optimal price for a pricing unit such that the price corresponds to the maximum value of the selected goal function. The most-recent optimal price determined by pricing module is herein referred to as a “current price” for the pricing unit. The pricing model includes an estimation of the actual demand for a given pricing unit. Details of the dynamic determination of price for a pricing unit based on an estimation of the actual demand for the pricing unit is described in greater detail herein.

### MODEL OF DEMAND FOR A PRICING UNIT

In certain embodiments of the invention, the dynamic determination of price for a pricing unit is based on an estimation of the actual demand for the pricing unit. In the embodiment, the demand is a measured quantity and is equal to the ratio of the number of buys to the number of looks (“L2B ratio”) for a pricing unit at a given price. In certain embodiments, the demand may be modeled as a binomial model with a “true demand”, q. The model of demand may vary from implementation to implementation. For the purpose of explanation, the model of demand is described herein with reference to a binomial model of demand. It will, however, be evident that various modifications and changes may be made thereto without departing from the broader spirit and scope of the invention. The scope of the invention includes other types of models of demand.

Thus, if a binomial model of demand is used, and if q is the true demand for a pricing unit at a given price for the pricing unit, then the Probability, P, that one will observe “nbuys” out of “nlooks” is given by:

$$P ( nlooks , nbuys \vert q ) = \frac{nlooks !}{nbuys ! ( nlooks - nbuys ) !} {( {q}^{nb uys} ( 1 - q ) )}^{nlooks - nbuys}$$

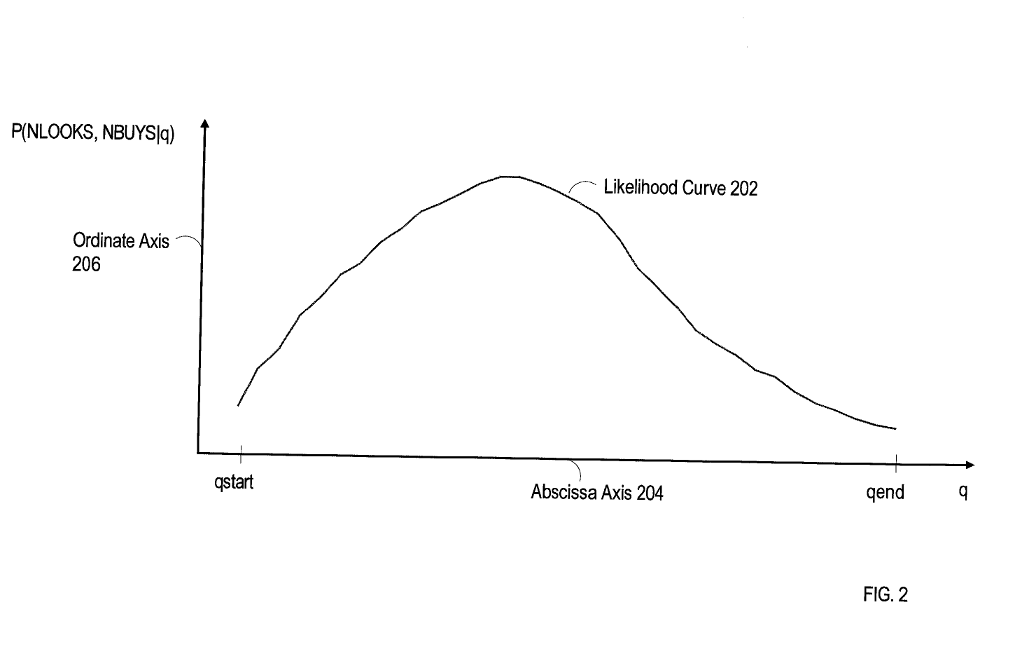

From the binomial distribution for a given demand measurement (L2B measurement) and from a range of possible values of q, the Likelihood L(q|nlooks, nbuys) of a hypothesized demand value q for a given measurement (nlooks, nbuys) may be obtained. The likelihood of the true demand being some value q, given a measurement (nlooks, nbuys) is equal to the binomial probability P(nlooks, nbuys|q) . The higher the likelihood, the more likely that q is the true demand. For example, FIG. 2 is a graph that illustrates a hypothetical likelihood curve 202, for a demand measurement. The probability of observing nbuys out of nlooks is represented on the ordinate axis 206, and a range of discrete values of q is represented on the abscissa axis 204, where,

$$Demand measurement ( the L2B ratio ) = \frac{nbuys}{nlooks} \\ [ {q}_{start} , {q}_{end} ] = {q}_{start} , {q}_{2} , {q}_{3} , … {q}_{end}$$

In certain embodiments, the model of demand may involve a continuous approximation of q instead of discrete values of q. One technique of continuous approximation of q is explained herein in the section entitled “Bayesian Updating of Probability Distribution”. In order to ensure that the demand measurement represents the true demand, periodic measurements of the L2B ratio are made until the probability distribution corresponding to the demand measurement reaches a user-determined confidence value. The confidence value of a probability distribution of the demand is the level of confidence that the true demand is within a user-selected confidence interval around the mean value of demand, μ. The mean value of demand, μ, is the sum of all the values of q multiplied by the probability corresponding to each value of q. Hence,

$$μ = {\sum }_{qstart}^{qend} qP ( q )$$

$$P ( q ∈ [ q0qf ] ) = {{\sum }_{q0}}^{qf} P ( q )$$

is the confidence value that the true demand is in the confidence interval [q0, qf]

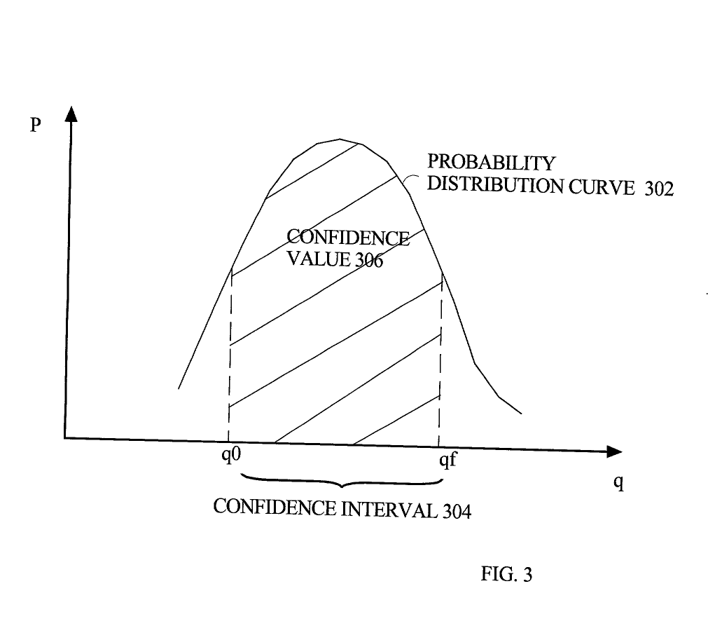

FIG. 3 is a graph that illustrates a confidence value. Confidence value 306 is the crosshatched area under probability distribution curve 302 within the confidence interval 304. The abscissa values q0 and qf define the upper and lower limits of the confidence interval and may be user-selected. For the purpose of explanation, assume that a user specifies that he would like a 95% confidence level that the true demand falls within ±10% of μ. A 95% confidence level means that 95% of the mass of the probability distribution for the demand falls within plus or minus 10% of the mean value of demand, μ.

The probability distribution of demand of a price candidate for a pricing unit is said to have converged when the confidence value of a user-specified interval around the expected or mean value (μ) for q has reached or exceeded a threshold selected by the user. It is assumed that a converged probability distribution represents the true demand for a given price. The idea is to take enough measurements until convergence. For example, assume that $X is a price candidate for Acme Umbrella Model B for customers in the South Eastern U.S. during the winter season. $X is offered by listing $X as price 110 on web page 106 of FIG. 1. Assume that the user selects a 95% confidence level that the true demand falls within ±10% of μ. During the offering operation, periodic demand measurements (L2B measurements) are taken of the number of looks and the number of buys and are (n₁looks, n₁buys), (n₂looks, n₂buys), . . . (n_{c}looks, n_{c}buys). A probability distribution is calculated for each demand measurement (L2B measurement). The probability distribution is updated for each consecutive demand measurement (L2B measurement) in order to take into account the current demand trend for the pricing unit. A method of updating the probability distribution is the Bayesian update, which is described in greater detail herein. Assume that the demand measurement (n_{f}looks, n_{f}buys) corresponds to a probability distribution that has a confidence value that has reached the user-selected 95% confidence value. Price candidate $X is said to have converged because the demand measurement (n_{f}looks, n_{f}buys) corresponds to a probability distribution that has a confidence value that has reached the user-selected 95% confidence value.

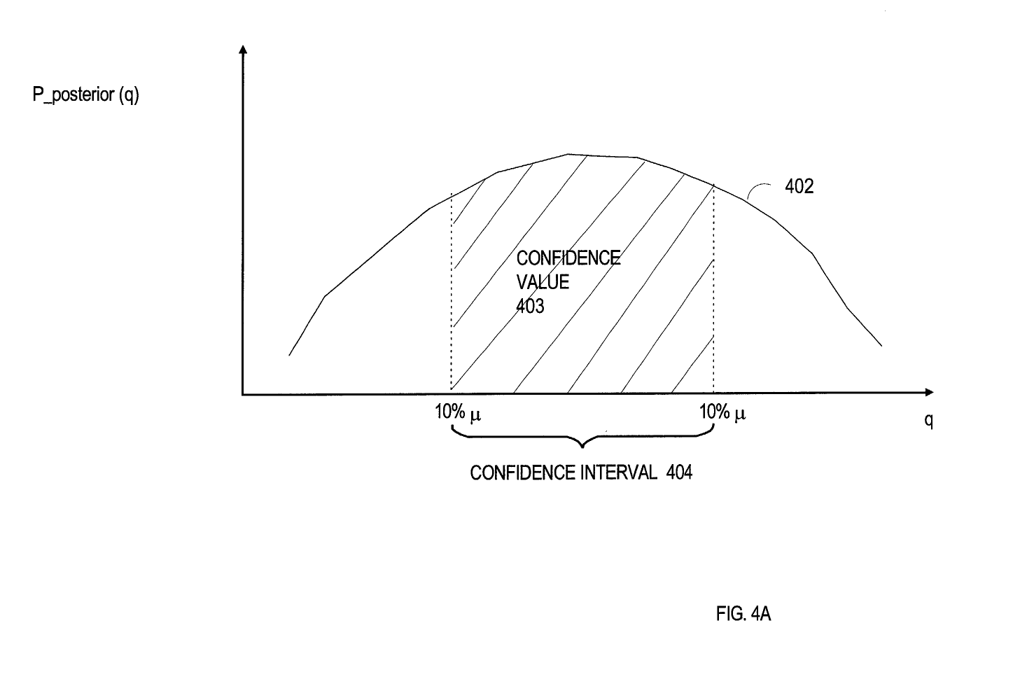

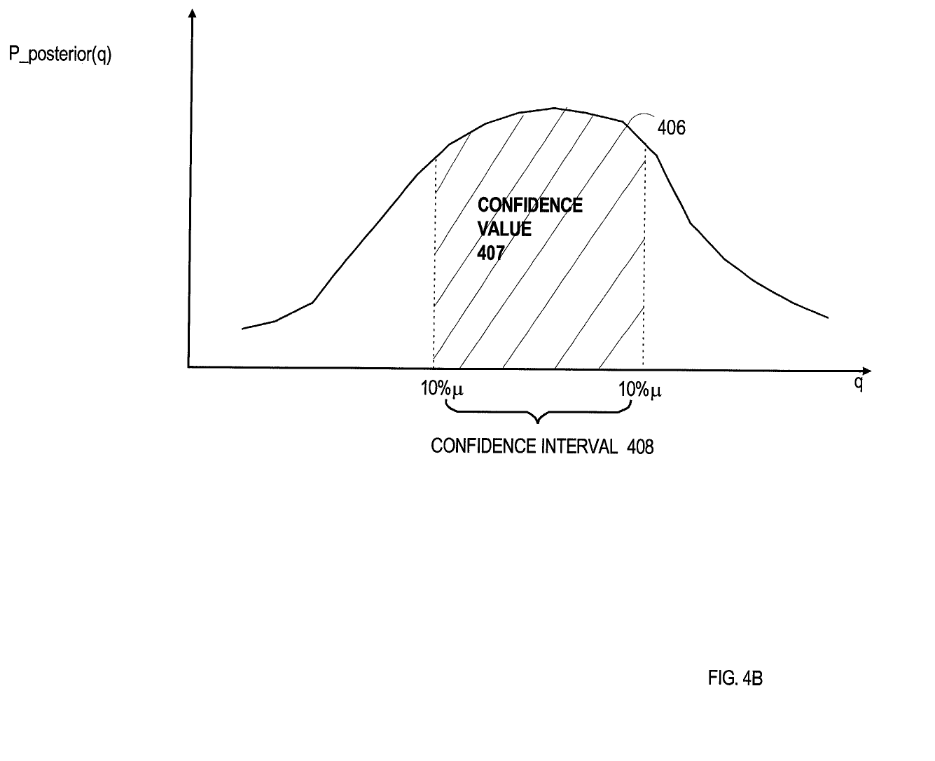

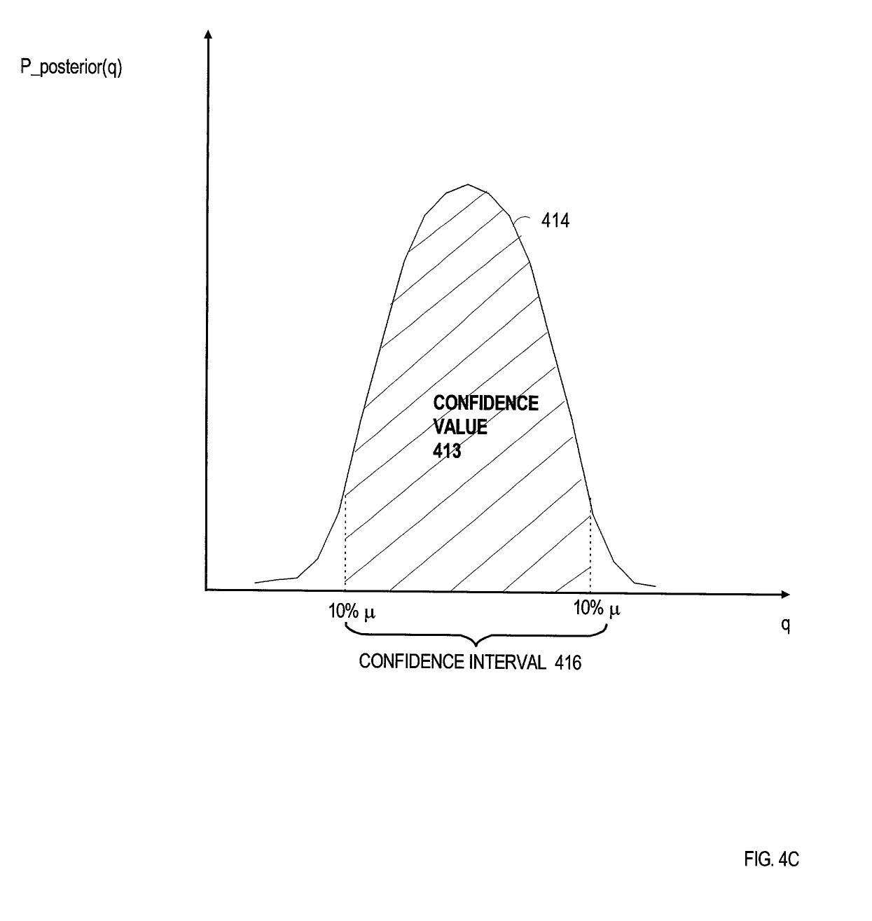

FIGS. 4A, 4B, and 4C illustrate a series of probability distributions for demand corresponding to the offering of price candidate $X. Confidence value 403 of FIG. 4A corresponds to the probability distribution for (n₁looks, n₁buys). Confidence value 403 within the confidence interval 404 is not 95% of the area under probability distribution curve 402. Similarly, confidence value 407 of FIG. 4B corresponds to the probability distribution for (n₂looks, n₂buys). Confidence value 407 within the confidence interval 408 is not 95% of the area under probability distribution curve 406. However, the confidence value 415 of FIG. 4C, which corresponds to the probability distribution for (n_{f}looks, n_{f}buys), within the confidence interval 416 is 95% of the area under probability distribution curve 414.

### BAYESIAN UPDATE OF PROBABILITY DISTRIBUTIONS

At the onset of the offering operation of a price candidate, when there is no prior demand measurements (L2B measurements) or data, the probability distribution for the demand is assumed to be uniform. The probability distribution for the demand is assumed to be uniform because any value of the demand is equally likely to be the true demand when there is no empirical evidence based on demand measurements (L2B measurements). However, as demand measurements (L2B measurements) are taken during the offering operation, the probability distribution corresponding to each successive demand measurement (L2B measurement) is updated. Updating the probability distribution for the demand may vary from implementation to implementation. For the purpose of explanation, the updating of the probability distribution for the demand is described herein with reference to a Bayesian update.

With each update, the probability distribution for the demand moves towards a distribution that corresponds to the true demand associated with the price candidate that is being offered. The Bayesian update is as follows:

$${P}_{posterior} ( demand = q ) = L ( q \vert nlooks , nbuys ) {P}_{prior} ( demand = q )$$

$$where , \\ L ( q \vert nlooks , nbuys ) = \frac{nlooks !}{nbuys ! ( nlooks - nbuys ) !} {( {q}^{nbuys} ( 1 - q ) )}^{nlooks - nbuys}$$

The updated probability distribution is Pₚₒₛₜₑᵣᵢₒᵣ(demand=q). The likelihood of receiving nbuys out of nlooks, corresponding to the current demand measurement, (n_{current}looks, n_{current}buys), and for various discrete values of q, is represented by L(q|nlooks, nbuys). Pₚᵣᵢₒᵣ(demand=q) is the prior updated probability distribution corresponding to the demand measurement that immediately preceded (temporally) the current demand measurement. As explained herein, for a given price candidate, demand measurements (L2B measurements) are taken and the probability distributions are updated until convergence is reached. A price candidate whose corresponding probability distribution of demand has reached convergence is herein referred to as a “converged price candidate”. A price candidate whose corresponding probability distribution of demand is the first to reach convergence is herein referred to as a “first-to-converge price candidate”.

In certain other embodiments, a closed form solution may be adopted for updating the probability distribution for the demand. For example, when using a binomial model for the demand, and the uniform distribution as the initial prior distribution (before any measurements are made), both Pₚₒₛₜₑᵣᵢₒᵣ and Pₚᵣᵢₒᵣ of the Bayesian update may be expressed as Beta distributions. The Beta distribution is a two-parameter distribution:

$$Beta ( q \vert α , β ) = \frac{Γ ( α + β )}{Γ ( α ) Γ ( β )} {( {q}^{a - 1} ( 1 - q ) )}^{β - 1}$$

where the gamma function is defined by,

$$Γ ( α ) = {\int }_{0}^{∞} {x}^{α - 1} {ⅇ}^{- x} ⅆ x .$$

The uniform distribution is a Beta distribution where α=β1. If the prior distribution of demand is a Beta(q|α, β), and the likelihood L(q|nlooks, nbuys ) is based on a binomial model, then the posterior distribution can be shown to be Beta(q |α+nbuys, β+(nlooks−nbuys)). Hence, the Bayesian update for a measurement (nlooks, nbuys) may be written as,

Pₚₒₛₜₑᵣᵢₒᵣ(demand=q)=Beta(q|αₚᵣᵢₒᵣ+nbuys, βₚᵣᵢₒᵣ+(nlooks−nbuys)).

The posterior mean is

$$\frac{{α}_{posterior}}{{α}_{posterior} + {β}_{posterior}} , and the variance$$

$$is \frac{{α}_{posterior} {β}_{posterior}}{{( {α}_{posterior} + {β}_{posterior} )}^{2} ( {α}_{posterior} + {β}_{posterior} + 1 )}$$

### UPDATING PROBABILITY DISTRIBUTIONS TO ACCOUNT FOR MOVEMENT OF THE TRUE DEMAND VALUE

One of the assumptions of the probability distribution model for the demand is that the true demand value corresponding to a price is fixed in time. However, the true demand value is usually not fixed in time. Thus, in order to account for movement of the true demand value, the probability distribution for the demand corresponding to a given price is periodically “reset”. The probability distribution for the demand corresponding to a given price is periodically “reset” by taking into account previous measurements of demand. Resetting of the probability distribution may vary from implementation to implementation. The invention is not limited to any particular technique of resetting of the probability distribution. However, for the purpose of explanation, the resetting of the probability distribution is described herein using a window averaging technique. For example, the probability distribution is reset by running an averaging window over the distribution. Every value, P(q), corresponding to each discretized value of q, in the distribution is replaced by the average of itself and N of its neighbors on either side of the value. The width, N, of the averaging window is selected according to estimated movement of the true demand from the point of convergence. The resetting of the probability distribution is analogous to taking window averages of demand measurements in time. Thus, resetting lessens the effect of measurements that are temporally distant from the demand measurement (L2B measurement) that is currently measured at a given time.

### PARALLEL OFFERING

In certain embodiments of the invention, in order to isolate the effect of price on the demand for a pricing unit, several price candidates are offered in parallel to determine an optimal price for the pricing unit. By offering several price candidates in parallel, any effect due to factors other than price on the demand corresponding to a price candidate will be nullified. The optimal price that is determined through the offering operation is herein referred to as the “current price” for the pricing unit.

Parallel offering of several price candidates for a pricing unit involves concurrently listing each of the price candidates on separate websites in order to make concurrent L2B (demand) measurements corresponding to each price candidate. In certain embodiments of the invention, each price candidate that is in the parallel offering operation has a status. The status maybe one of the following: 1) baseline, 2) accepted, 3) rejected, 4) active, or 5) untested.

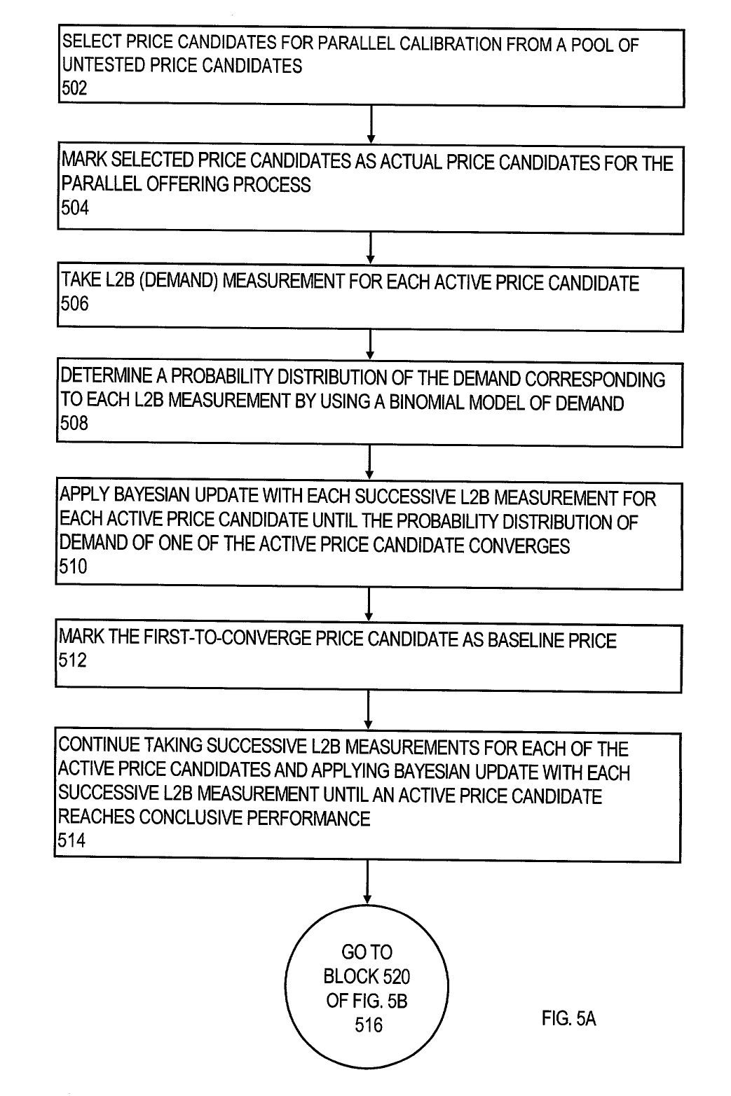

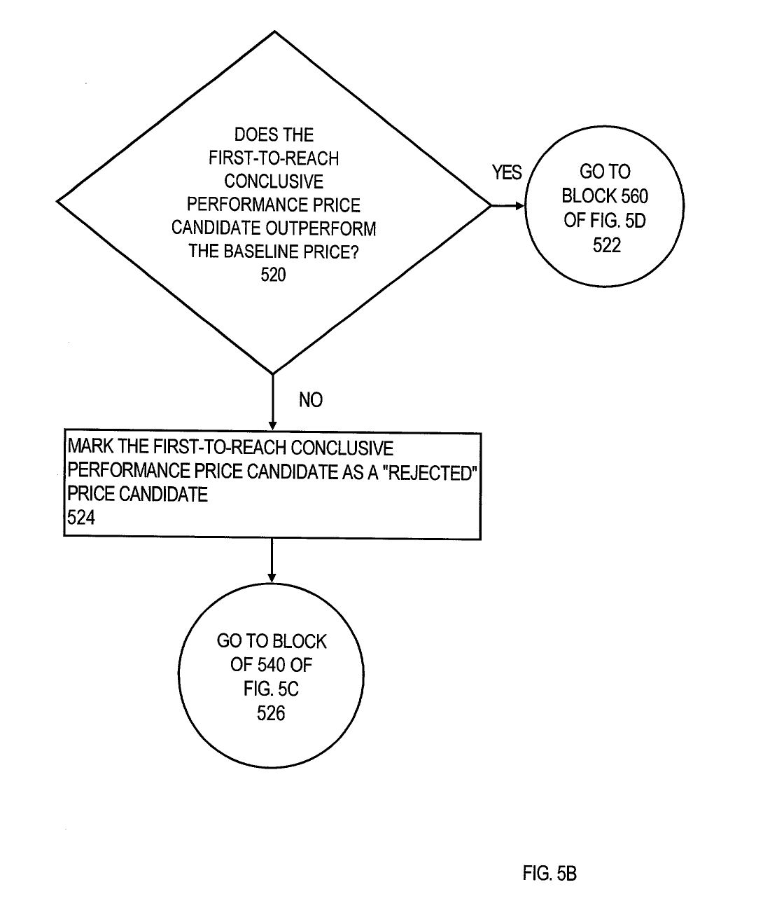

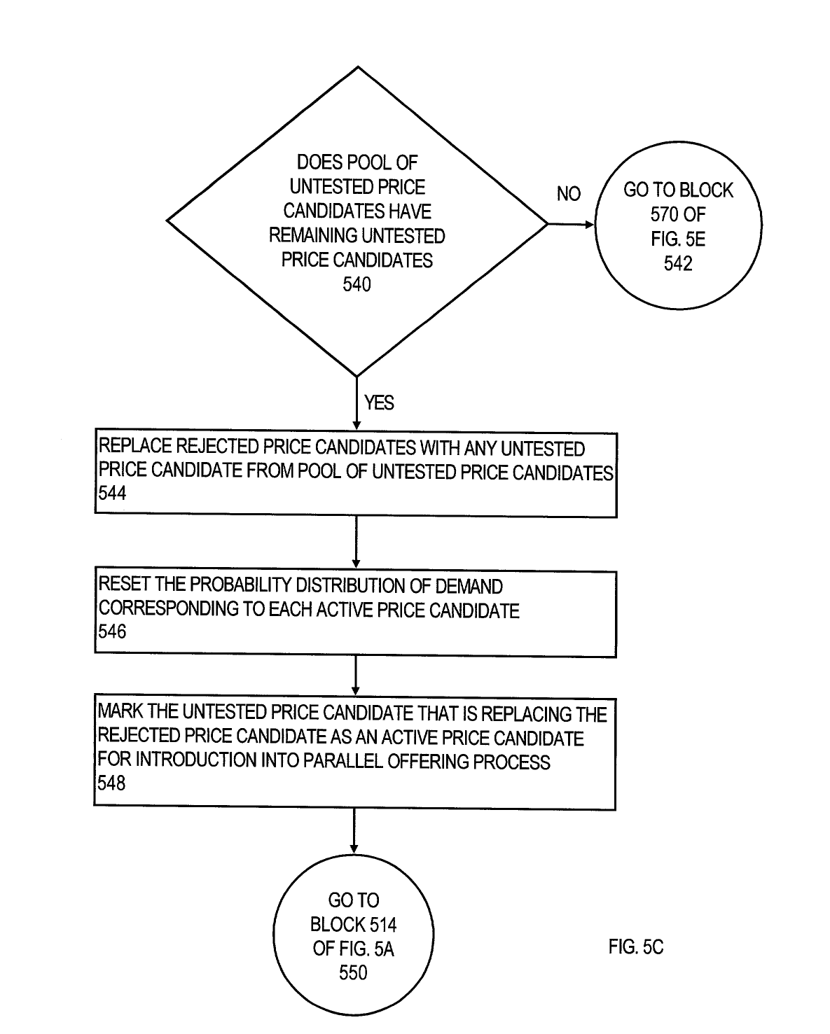

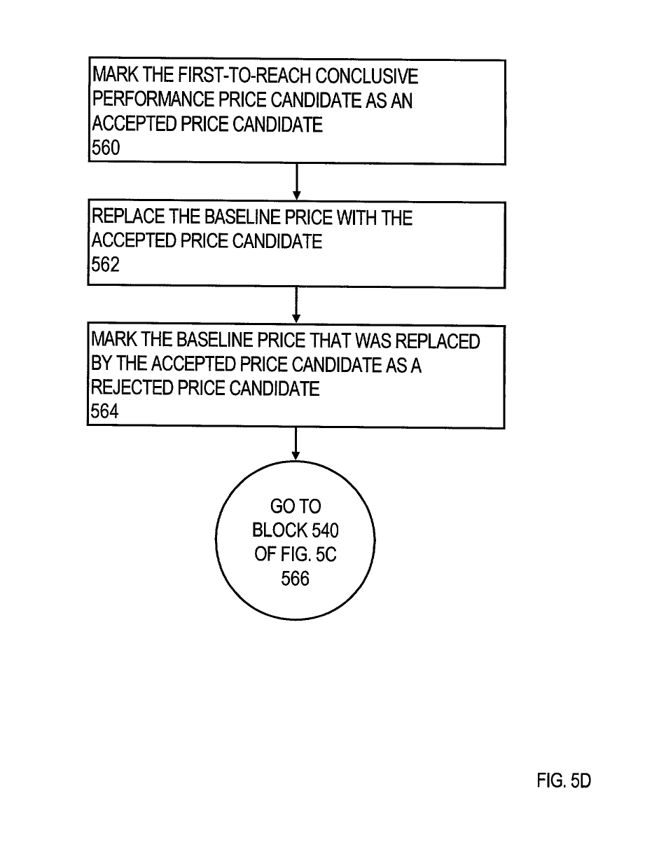

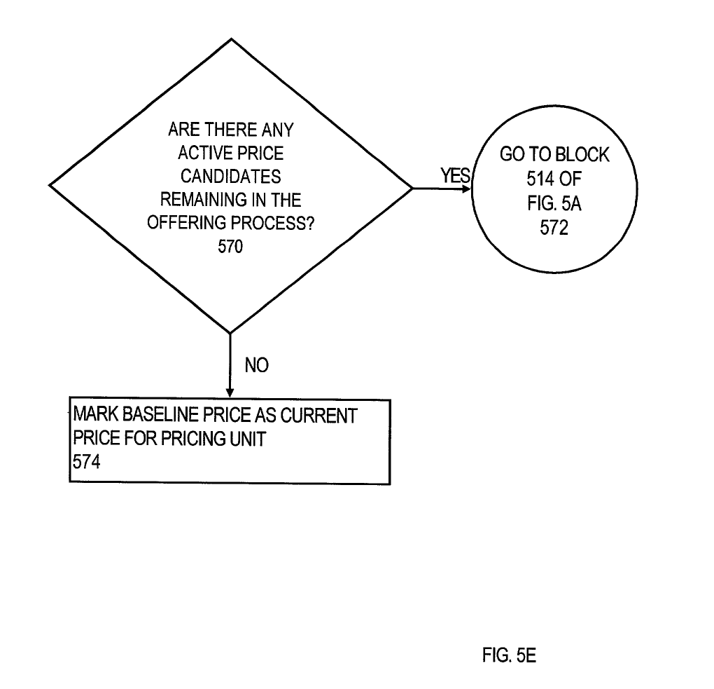

FIGS. 5A, 5B, 5C, 5D, 5E are flowcharts that illustrate a method of parallel offering. In FIG. 5A, at block 502, price candidates are selected from a pool of untested price candidates. A vendor may supply the actual untested price candidates or provide specifications for the selection of untested price candidates. For example, the vendor may specify a minimum price, a maximum price, and a maximum number of price candidates. At block 504, the selected price candidates are marked as active price candidates for the parallel offering operation.

At block 506, a L2B (demand) measurement is taken for each active price candidate. At block 508, a probability distribution of demand is determined corresponding to each L2B measurement by using the probability distribution model as explained herein. At block 510, for each active price candidate, a Bayesian update is applied to the active price candidate's corresponding probability distribution with each successive L2B measurement that is taken for that active price candidate. The Bayesian update is applied until the probability distribution of demand of one of the active price candidates converges. For example, the manner of convergence is described herein in the section “Model of Demand For a Pricing unit”. However, the embodiment of the invention is not restricted to any particular model of demand.

At block 512, the first-to-converge price candidate is marked as a baseline price candidate. At block 514, successive L2B measurements for each of the active price candidates are continued to be made and the Bayesian update is applied as described herein with each successive L2B measurement until one of the active price candidates reaches “conclusive performance”. Conclusive performance for an active price candidate means that a user-selected percentage of the mass of the probability distribution of demand corresponding to the active price candidate falls on one side of a “target demand” on a graph of the probability distribution of demand. The user-selected percentage of the mass of the probability distribution with respect to conclusive performance is herein referred to as a “conclusive performance percentage”. The target demand is the demand that an active price candidate needs to achieve in order to perform as well as the baseline price for a given goal function. If the baseline price is $BP, the L2B measurement corresponding to $BP is L2B_{bp}, and the goal function is revenue, fᵣₑᵥₑₙᵤₑ, then the target demand is determined as follows:

fᵣₑᵥₑₙᵤₑ($BP)=($BP)(L2B_{bp})

$$Target demand = \frac{( \$ B P ) ( {L2B}_{bp} )}{Active price candidate}$$

The goal function and target demand as described above are merely illustrative. The invention is not restricted to any particular goal function. The conclusive performance percentage of the mass of the probability distribution is typically selected to be less than the user-selected confidence level that is associated with convergence. For example, if the user-selected confidence level is 95%, the conclusive performance percentage may be selected to be about 75% to 90%. The active price candidate that is the first to reach conclusive performance is herein referred to as a “first-to-reach-conclusive-performance” price candidate. At block 516, control is passed to block 520 of FIG. 5B.

At block 520, it is determined whether the first-to-reach-conclusive-performance price candidate outperforms the baseline price. The first-to-reach-conclusive-performance price candidate is determined to outperform the baseline price if the conclusive performance percentage of the mass of the probability distribution of demand corresponding to the first-to-reach-conclusive-performance price candidate exceeds the target demand (i.e., falls on the right side of the “target demand” on a graph of the probability distribution of demand). If the first-to-reach-conclusive-performance price candidate is determined to outperform the baseline price, then at block 522, control passes to block 560 of FIG. 5D. Otherwise, at block 524, the first-to-reach-conclusive-performance price candidate is marked as a rejected price candidate. At block 526, control is passed to block 540 of FIG. 5C.

At block 540, it is determined whether the pool of untested price candidates has remaining untested price candidates. If it is determined that there are no remaining untested price candidates in the pool of untested price candidates, then at block 542, control is passed to block 570 of FIG. 5E. Otherwise, at block 544, the rejected price candidate is replaced with any untested price candidate from the pool of untested price candidates. At block 546 the probability distribution of demand corresponding to each active price candidate is reset in the manner as explained above in the section, “Updating Probability Distributions To Account For Movement Of The True Demand Value.” At block 548, the untested price candidate that is replacing the rejected price candidate is marked as an active price candidate for introduction into the parallel offering operation. At block 550, control is returned to block 514 of FIG. 5A.

At block 560 of FIG. 5D, the first-to-reach-conclusive-performance price candidate is marked as an accepted price candidate. At block 562, the baseline price is replaced with the accepted price candidate that was marked at block 560. At block 564, the baseline price that was replaced by the accepted price candidate is marked as a rejected price candidate. At block 566, control is returned to block 540 of FIG. 5C.

At block 570 of FIG. 5E, it is determined whether there are any active price candidates remaining in the parallel offering operation. If it is determined that there are no active price candidates remaining in the parallel offering operation, then at block 574, the baseline price is marked as the current price for the pricing unit. Otherwise, at block 572, control is returned is to block 514 of FIG. 5A.

### SERIAL OFFERING

In certain embodiments of the invention, price candidates are offered one at a time rather than in parallel. In order to account for movement of the true demand value in a serial offering, a price candidate is not offered straight through until convergence. Instead of offering a price candidate straight through until convergence is reached, the price candidate is offered until a pre-selected condition is satisfied. According to one embodiment, the pre-selected condition involves reaching a particular threshold of demand value.

When the pre-selected (pre-determined) threshold is reached, the price candidate is marked as “pending”. Offering is temporarily halted for the pending price candidate and a second price candidate is brought in for serial offering. Offering of the second price candidate continues until the second price candidate may be marked as “pending”. Once there is a pair of pending price candidates, one of the pending price candidates is selected for serial offering until convergence. The converged price candidate is used as a baseline price, and the other pending price candidate in the pair of pending price candidates is offered and compared against the baseline price. If the pending price candidate performs better than the baseline price, then the baseline price will be rejected and the pending price candidate emerges as the “surviving baseline price”. However, if the pending price candidate performs worse than the baseline price, then the pending price candidate is rejected and the baseline price is the surviving baseline price.

The number of times that the offering switches between price candidates may vary from implementation to implementation. For example, during time intervals t1, t2, t3, t4, t5 and t6, the price offerings may be p1, p2, p1, p2, p1 and p2, where p1 and p2 are two candidate prices. Further, just as the more than two price candidates may be offered during a parallel offering, more than two price candidates may be interleaved during serial offerings. For example, during time intervals t1, t2, t3, t4, t5 and t6, the price offerings may be p1, p2, p3, p1, p2 and p3, where p1, p2 and p3 are three candidate prices.

The probability distribution corresponding to the surviving baseline price is reset and the serial offering operation as described herein, starts over again. The serial offering is repeated until no more price candidates remain to be offered. The last surviving baseline price becomes the current price for the pricing unit.

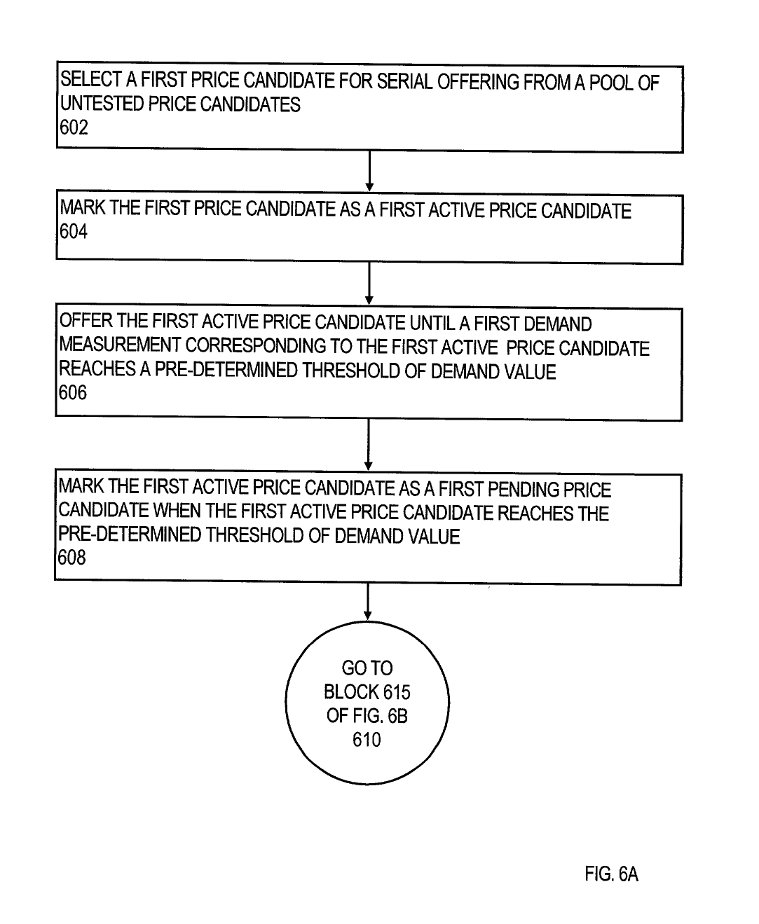

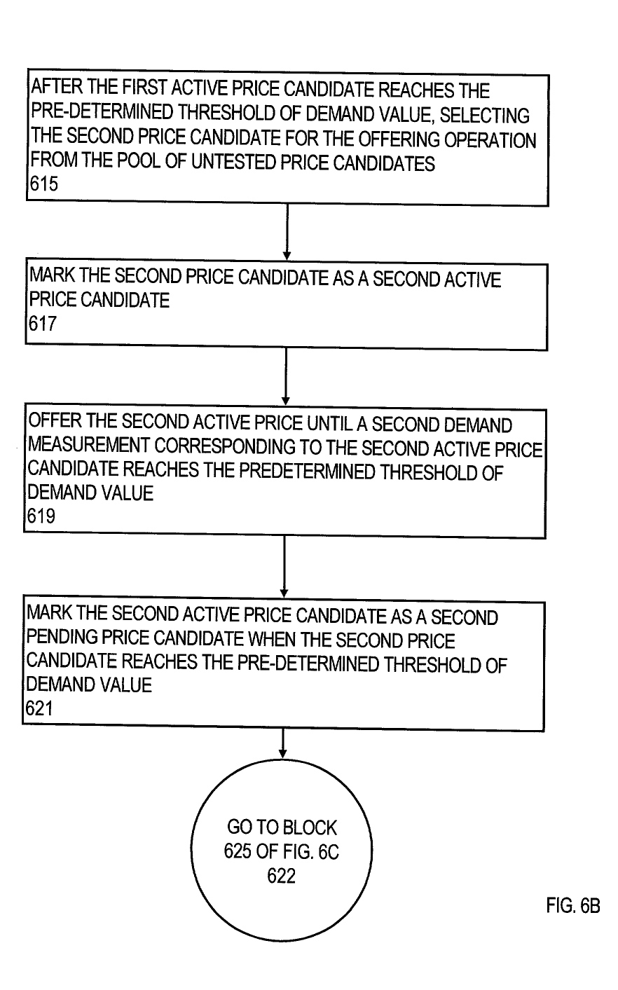

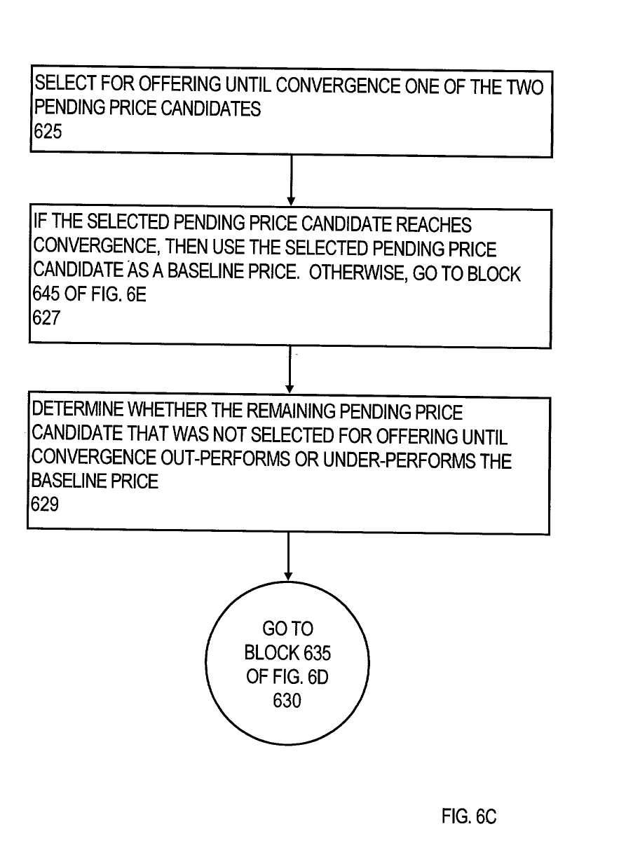

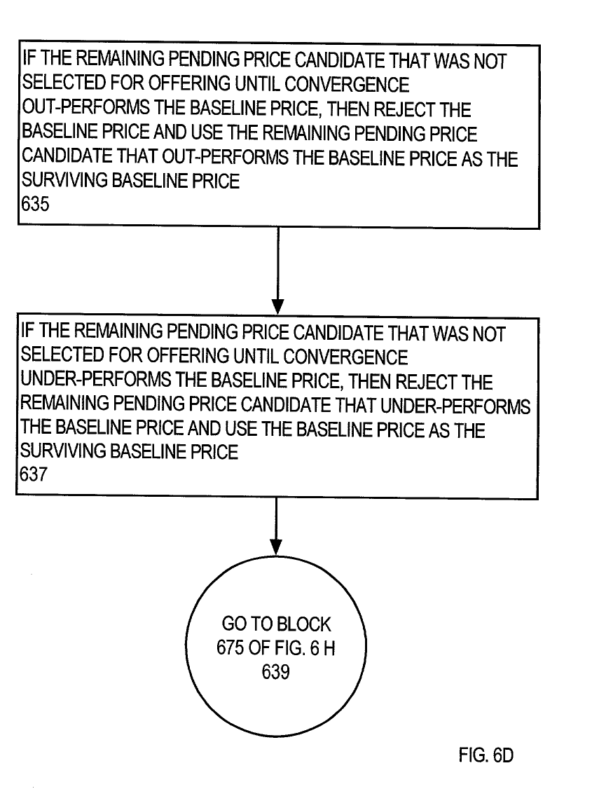

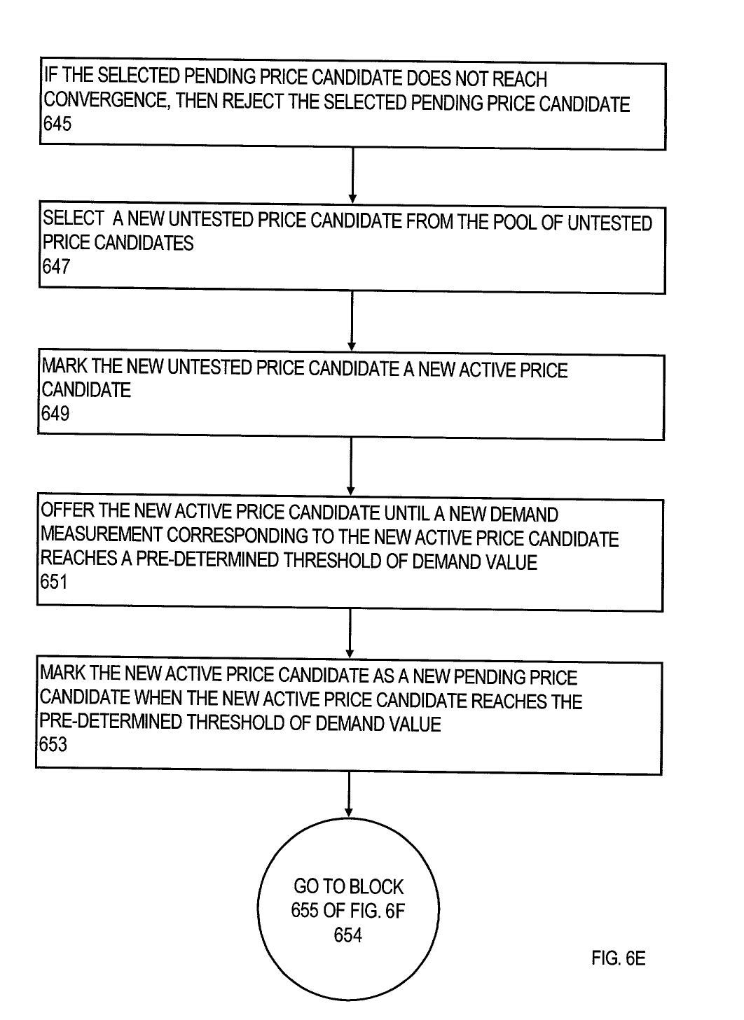

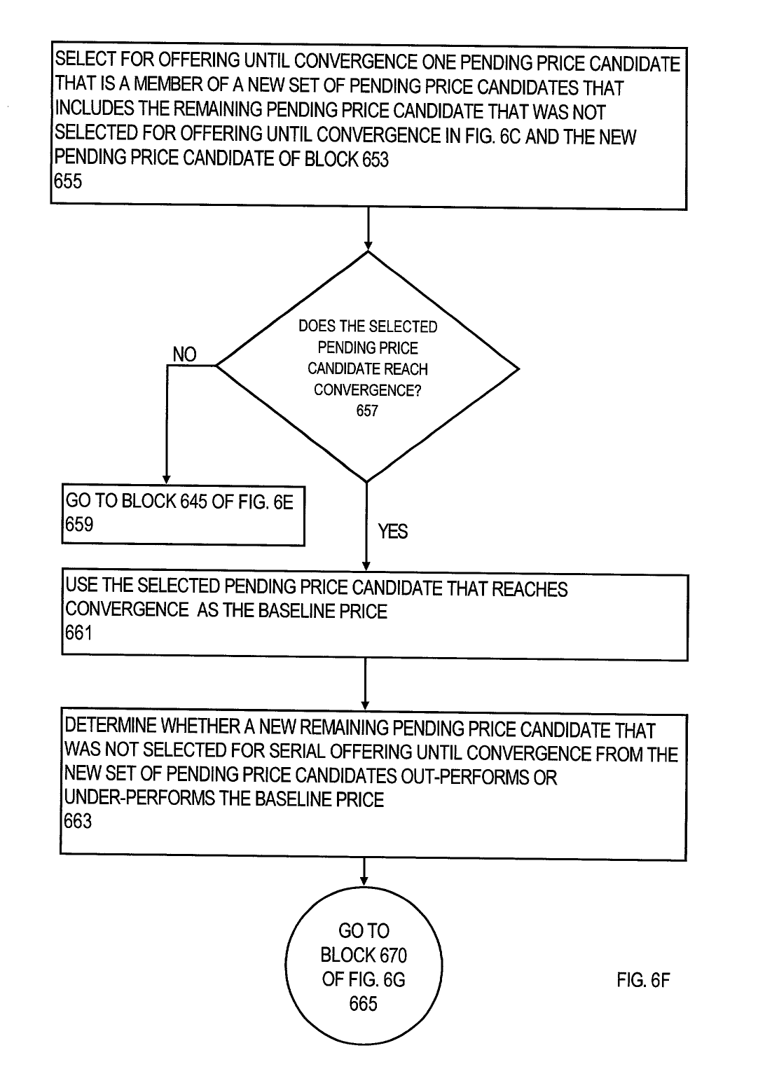

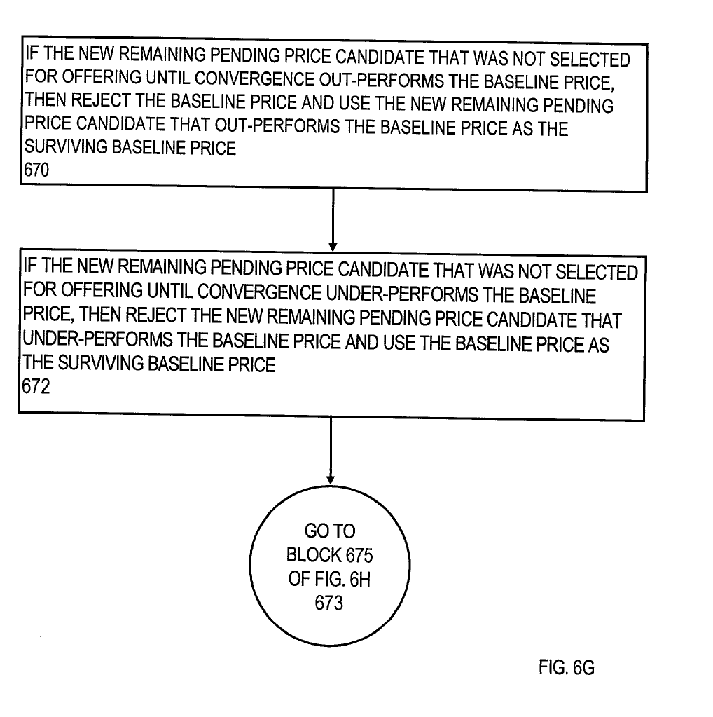

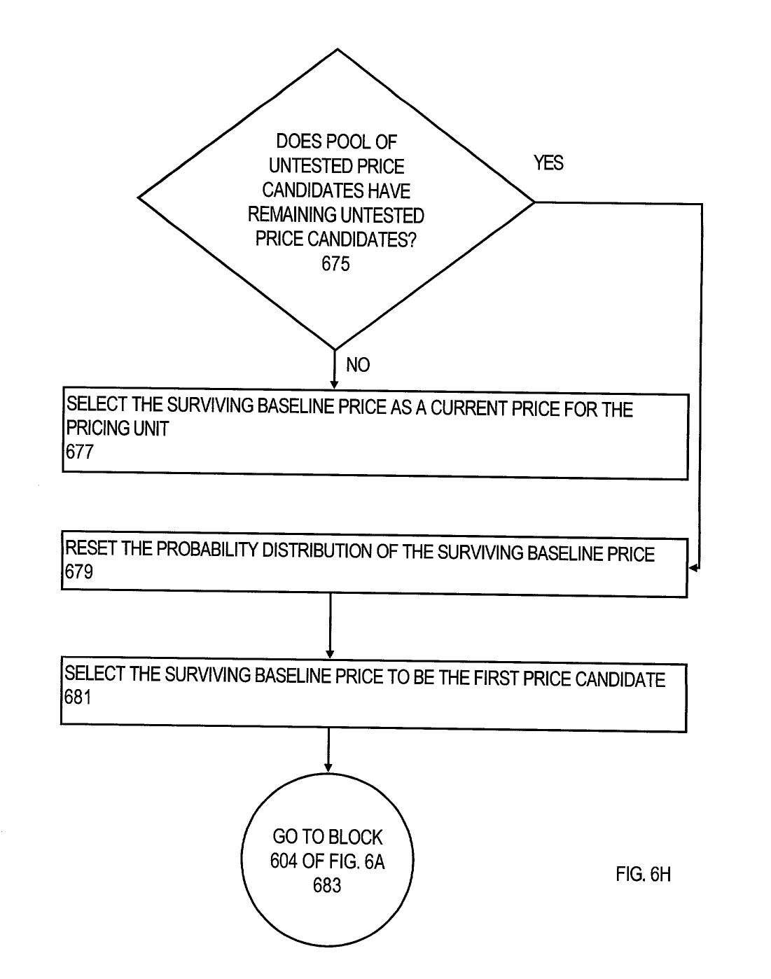

FIGS. 6A, 6B, 6C, 6D, 6E, 6F, 6G, 6H are flowcharts that illustrate the serial offering operation. At block 602 of FIG. 6A, a first price candidate for serial offering is selected from a pool of untested price candidates. At block 604, the first price candidate is marked as a first price candidate for introduction into the serial offering operation. At block 606, the first active price candidate is offered until a first demand measurement (L2B measurement) corresponding to the first active price candidate reaches a pre-determined threshold of demand value. In other words, successive L2B measurements are taken for the first active price candidate. A probability distribution of demand is determined corresponding to each L2B measurement. For example, in certain embodiments of the invention, the probability distribution of demand may be determined by using the probability distribution model as explained herein. Also, a Bayesian update is applied to the probability distribution of demand with each successive L2B measurement that is taken for the first price candidate. The Bayesian update is applied until the probability distribution of demand reaches a pre-determined threshold of demand value. Typically, the pre-determined threshold of demand value is user selected and is a value that is relatively less in magnitude than the user-determined confidence value described herein.

At block 608, the first active price candidate is marked as a first pending price candidate when the first active price candidate reaches the pre-determined threshold of demand value. At block 610, control is passed to block 615 of FIG. 6B.

At block 615, after the first price candidate reaches the pre-determined threshold of demand value, a second price candidate is selected for the serial offering operation from the pool of untested price candidates. At block 617, the second price candidate is marked as an active price candidate. At block 619, the second active price candidate is offered until a second demand measurement (L2B measurement) corresponding to the second active price candidate reaches the pre-determined threshold of demand value in the manner as explained above. At block 621, the second active price candidate is marked as a second pending price candidate when the second price candidate reaches the pre-determined threshold of demand value. At block 622, control is passed to block 625 of FIG. 6C.

At block 625, one of the two pending price candidates is selected for offering until convergence. Convergence is described herein in the subsection “Model of Demand For a Pricing Unit”. At block 627, if the selected pending price candidate reaches convergence, then the selected pending price candidate is used as a baseline price. If the selected pending price candidate does not reach convergence, then control is passed to block 645 of FIG. 6E. At block 629, it is determined whether the remaining price candidate that was not selected for offering until convergence out-performs or under-performs the baseline price. The manner of out-performing or under-performing the baseline price is previously described above. At block 630, control passed to block 635 of FIG. 6D.

At block 635, if the remaining pending price candidate that was not selected for offering until convergence out-performs the baseline price, then the baseline price is rejected and the remaining pending price candidate that out-performs the baseline price is used as the surviving baseline price. At block 637, if the remaining pending price candidate that was not selected for offering until convergence under-performs the baseline price, then the remaining pending price candidate that under-performs the baseline price is rejected and the baseline price is used as the surviving baseline price. At block 639, control is passed to block 675 of FIG. 6H.

At block 645 of FIG. 6E, if the selected pending price candidate does not reach convergence, then the selected pending price candidate is rejected. At block 647, a new untested price candidate is selected from the pool of untested price candidates. At block 649, the new untested price candidate is marked as a new active price candidate. At block 651, the new active price candidate is offered until a new demand measurement (L2B measurement) corresponding to the new active price candidate reaches a pre-determined threshold of demand value. At block 653, the new active price candidate is marked as a new pending price candidate when the new active price candidate reaches the pre-determined threshold of demand value. At block 654, control is passed to block 655 of FIG. 6F.

At block 655, one pending price candidate is selected for offering until convergence. The one pending price candidate is a member of a new set of pending price candidates that includes the remaining pending price candidate that was not selected for offering until convergence in FIG. 6C and the new pending price candidate of block 653. At block 657, it is determined whether the selected pending price candidate reaches convergence. If the selected pending price candidate does not reach convergence, then at block 659, control is returned to block 645 of FIG. 6E. Otherwise, at block 661, the selected pending price candidate that reaches convergence is used as the baseline price. At block 663, it is determined whether a new remaining pending price candidate that was not selected for serial offering until convergence from the new set of pending price candidates out-performs or under-performs the baseline price. At block 665, control is passed to block 670 of FIG. 6G.

At block 670, if the new remaining pending price candidate that was not selected for offering until convergence out-performs the baseline price, then the baseline price is rejected and the new remaining pending price candidate that out-performs the baseline price is used as the surviving baseline price. At block 672, if the new remaining pending price candidate that was not selected for offering until convergence under-performs the baseline price, then the new remaining pending price candidate that under-performs the baseline price is rejected and the baseline price is used as the surviving baseline price. At block 673, control is passed to block 675 of 6H.

At block 675, it is determined whether the pool of untested price candidates has remaining untested price candidates. If the pool of untested price candidates has no remaining untested price candidates, then at block 677, the surviving baseline price is selected as the current price for the pricing unit. Otherwise, at block 679, the probability distribution of demand corresponding to surviving baseline price is reset in the manner as explained above in the section, “Updating Probability Distributions To Account For Movement Of The True Demand Value.” At block 681, the surviving baseline price is selected to be the first price candidate. At block 683, control is returned to block 604 of FIG. 6A.

### MONITOR

According to one embodiment of the invention, once a current price is determined by either the serial or parallel offering operation, a monitor operation monitors the current price to check for any movement of the true demand value. Recall that the “current price” for given pricing unit is the optimal price that is most-recently determined through offering. The demand value of a freshly offered current price is assumed to be the true demand value. However, the true demand value is expected to move over time with the change in market trends. Monitoring of the current price involves taking periodic L2B measurements of the current price. For example, it is determined whether a L2B ratio that is measured during the monitor operation falls within a pre-determined interval around the mean demand value of the current price. The mean demand value of the current price is the mean value at the time when the current price was freshly offered. The pre-determined demand interval may be user selected. For the purpose of simplicity, a L2B ratio that is measured during the monitor operation, and which corresponds to the current price will herein be referred to as a “most-recent” demand measurement (L2B measurement).

In certain embodiments of the invention, if a most-recent demand measurement (L2B measurement) falls outside the predetermined interval by a small amount, then the monitor operation adjusts the current price by simply changing the current price automatically without re-offering. For example, the monitor operation may adjust the current price only when the most-recent demand measurement (L2B measurement) exceeds plus or minus 5% of the mean demand value that was determined at the time when the current price was freshly offered. However, if the most-recent demand measurement (L2B measurement) falls outside the pre-determined interval by a significant amount, then the monitor operation may trigger the restart of the offering operation described herein using a new pool of untested price candidates. Also, the need for frequent automatic price adjustments to the current price may warrant restarting the offering operation. In certain embodiments of the invention, if the number of price adjustments to the current price exceeds a user-selected number of price adjustments, then the monitor operation may trigger the restart of either the parallel offering operation or the serial offering operation to determine a new current price.

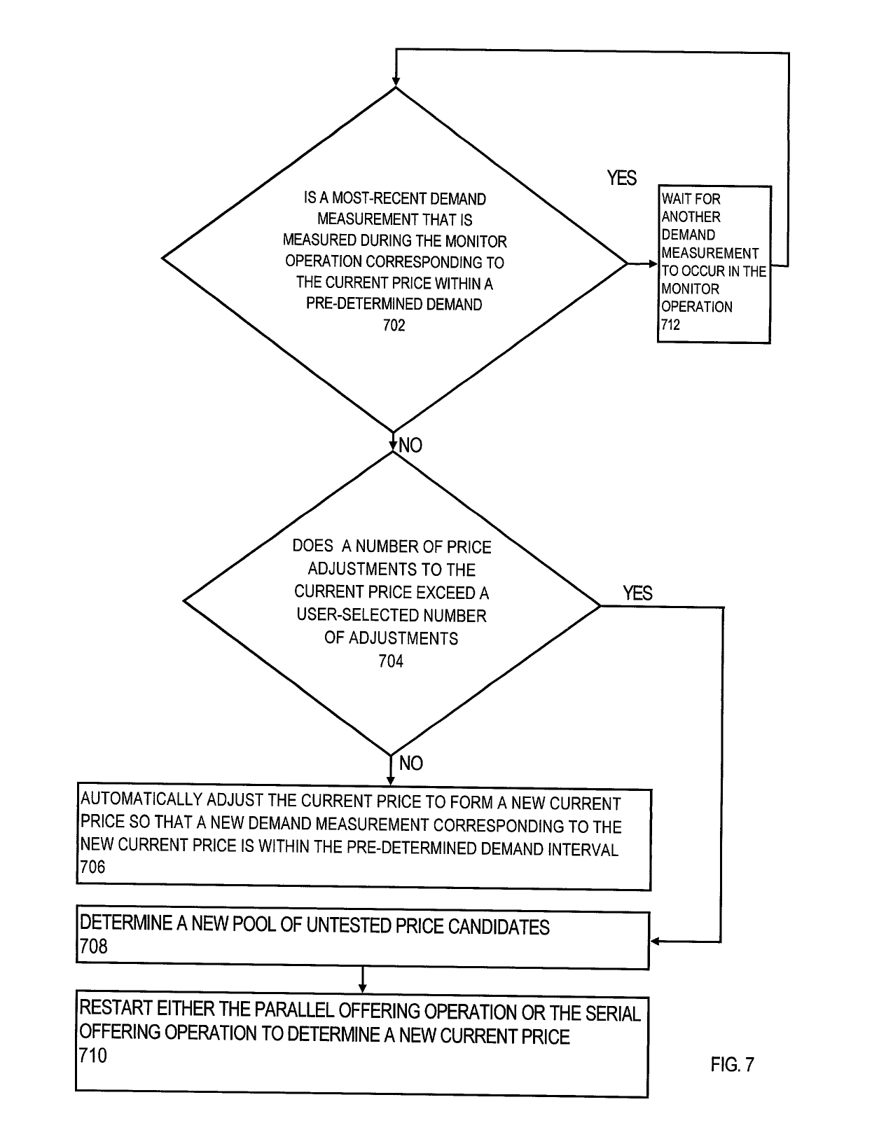

FIG. 7 is a flowchart that illustrates the monitor operation. At block 702, it is determined if the most-recent demand measurement (L2B measurement) falls within the pre-determined demand interval. If the most-recent demand measurement (L2B measurement) falls within the pre-determined demand interval, then at block 712, the monitor process waits for another demand measurement (L2B measurement) to be measured in the monitor operation. However, if the most-recent demand measurement (L2B measurement) falls outside the pre-determined demand interval, then at block 704, it is determined whether the number of price adjustments to the current price exceeds a user-selected number of adjustments. If it is determined that the number of price adjustments to the current price does not exceed a user-selected number of adjustments, then at block 706, the current price is automatically adjusted to form a new price so that a new demand measurement (L2B measurement) corresponding to the new current price is within the pre-determined demand interval. Otherwise, at block 708, a new pool of untested price candidates is determined. At block 710, either the parallel offering operation or the serial offering operation is restarted using the new pool of untested price candidates to determine a new current price.

### HARDWARE OVERVIEW

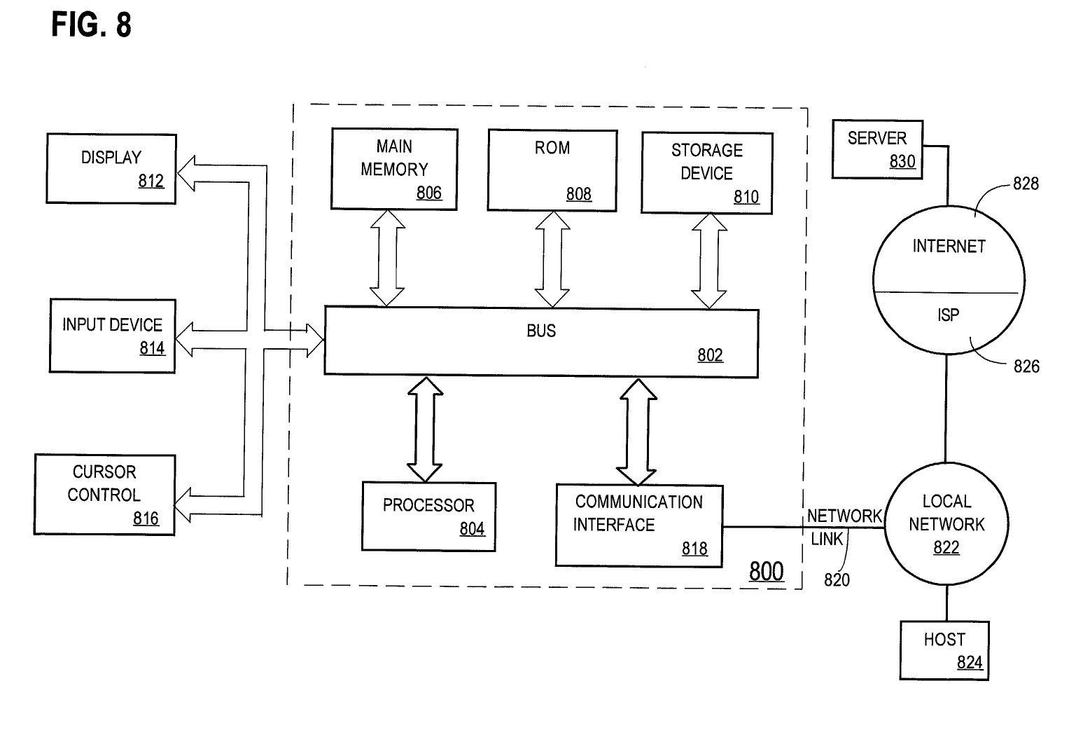

FIG. 8 is a block diagram that illustrates a computer system 800 upon which an embodiment of the invention may be implemented. Computer system 800 includes a bus 802 or other communication mechanism for communicating information, and a processor 804 coupled with bus 802 for processing information. Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

The invention is related to the use of computer system 800 for implementing the techniques described herein. According to one embodiment of the invention, those techniques are implemented by computer system 800 in response to processor 804 executing one or more sequences of one or more instructions contained in main memory 806. Such instructions may be read into main memory 806 from another computer-readable medium, such as storage device 810. Execution of the sequences of instructions contained in main memory 806 causes processor 804 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 804 for execution. Such a medium may take many forms, including but not limited to, non-volatile media, volatile media, and transmission media. Non-volatile media includes, for example, optical or magnetic disks, such as storage device 810. Volatile media includes dynamic memory, such as main memory 806. Transmission media includes coaxial cables, copper wire and fiber optics, including the wires that comprise bus 802. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 804 for execution. For example, the instructions may initially be carried on a magnetic disk of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822 For example, communication interface 818 may be an integrated services digital network (ISDN) card or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are exemplary forms of carrier waves transporting the information.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818. In accordance with the invention, one such downloaded application implements the techniques described herein.

The received code may be executed by processor 804 as it is received, and/or stored in storage device 810, or other non-volatile storage for later execution. In this manner, computer system 800 may obtain application code in the form of a carrier wave.

### SCOPE

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for pricing a pricing unit, the method comprising the computer-implemented steps of:
during a particular time interval, concurrently offering the pricing unit at a plurality of price candidates;
making one or more L2B measurements for each of the plurality of price candidates for the particular time interval;
performing a comparison between the L2B measurements for the plurality of price candidates; and
determining how to price the pricing unit based on the comparison.

2. The method of claim 1, wherein concurrently offering the pricing unit further comprises the steps of:
selecting the plurality of price candidates for a parallel offering operation from a pool of untested price candidates;
marking the plurality of price candidates as a plurality of active price candidates;
concurrently calibrating all active price candidates of the plurality of price candidates until there are no more active price candidates remaining to be calibrated; and
using in the parallel offering operation a model of demand to represent the demand corresponding to each price candidate, wherein the model of demand reflects a current L2B measurement.

3. The method of claim 2, wherein the model of demand comprises a binomial model of demand.

4. The method of claim 2, wherein the model of demand comprises performing a probabilistic estimation of a L2B ratio based on a Bayesian update of a binomial model of demand.

5. The method of claim 4, wherein the Bayesian update includes using a Beta distribution to represent both a prior probability distribution of demand and a posterior probability distribution of demand.

6. The method of claim 2, wherein the model of demand comprises one or more periodic resettings of a probability distribution of demand by temporally discounting previous L2B measurements in the probability distribution of demand corresponding to each price candidate.

7. The method of claim 6, wherein the one or more periodic resettings of the probability distribution of demand includes performing a window averaging of each ordinate value of a prior probability distribution of demand corresponding to each price candidate.

8. The method of claim 2, wherein the pool of untested price candidates is user-selected.

9. The method of claim 2, wherein selecting the plurality of price candidates for parallel offering is user-defined.

10. The method of claim 2, wherein concurrently offering the plurality of price candidates further comprises the steps of:
using as a baseline price, a first-to-converge active price candidate from the plurality of active price candidates;
marking as a rejected price candidate any active price candidate that is determined as under-performing the baseline price and simultaneously performing the steps of:
if the pool of untested candidates has any remaining untested price candidates then replacing the rejected price candidate with any untested price candidate from the pool of untested price candidates;
marking the untested price candidate that is replacing the rejected price candidate as active for introduction into the plurality of active price candidates for concurrent offering in the parallel offering operation; and
updating a probability distribution of demand corresponding to each active price candidate.

11. The method of claim 10, wherein the first-to-converge price candidate is obtained by using the model of demand that comprises performing a probabilistic estimation of a L2B ratio based on a Bayesian update of the probability distribution of demand.

12. The method of claim 10, wherein updating a probability distribution of demand comprises performing a window averaging of each ordinate value of the probability distribution of demand for the pricing unit corresponding to each price candidate.

13. The method of claim 10, wherein any rejected price candidate is removed from the parallel offering operation.

14. The method of claim 10, further comprising the steps of:
marking as an accepted price candidate any active price candidate that is determined out-performing the baseline price and immediately replacing the baseline price with the accepted price candidate and simultaneously performing the steps of:
marking the baseline price that was replaced by the accepted price candidate as one of the rejected price candidates;
marking the accepted price candidate that replaced the baseline price as the baseline price;
if the pool of untested candidates has remaining untested candidates then replacing the rejected price candidate with any untested price candidate from the pool of untested price candidates;
marking the untested price candidate that is replacing the rejected price candidate as another active price candidate for introduction into the plurality of active price candidates for concurrent offering; and
updating the probability distribution of demand corresponding to each active price candidate.

15. The method of claim 10, further comprising the steps of:
if the pool of untested candidates has no remaining untested candidates then determining whether there are any remaining active price candidates being concurrently tested; and
if it is determined that there are no remaining active price candidates, then marking the baseline price as a current price for the pricing unit.

16. The method of claim 1, further comprising the steps of:
monitoring a current price of the pricing unit during a monitor operation to determine whether a most-recent demand measurement (L2B measurement) that is measured during the monitor operation corresponding to the current price is within a predetermined demand interval; and
if the most-recent demand measurement (L2B measurement) is not within the predetermined demand interval, then adjusting the current price to form a new current price so that a new most-recent demand measurement (L2B measurement) corresponding to the new current price is within the predetermined demand interval.

17. The method of claim 16, wherein adjusting the current price comprises automatically changing the current price without re-calibrating any price candidates.

18. The method of claim 16, further comprising the step of:
if the most-recent demand measurement (L2B measurement) is not within the predetermined demand interval and a number of price adjustments to the current price exceeds a user-selected number of price adjustments, then determining a new pool of untested price candidates; and
restarting a parallel offering operation using the new pool of untested price candidates.

19. The method of claim 16, wherein the predetermined demand interval is user-selected.

20. The method of claim 16, wherein the predetermined demand interval surrounds a mean demand value corresponding to the current price.

21. The method of claim 10 further comprising restarting the parallel offering operation using a new pool of untested price candidates when no baseline price emerges from the parallel offering operation.

22. A method for pricing a pricing unit, the method comprising the computer-implemented steps of:
during a series of time intervals, alternating between offering the pricing unit at a plurality of price candidates;
wherein the pricing unit is offered at a first price candidate during at least a first time interval and a third time interval, and the pricing unit is offered at a second price candidate during at least a second time interval that occurs after the first time interval and before the third time interval;
making one or more demand measurements (L2B measurements) for each of the plurality of price candidates based on sales of the pricing unit during the series of time intervals;
performing a comparison between the demand measurements (L2B measurements) for the plurality of price candidates; and
determining how to price the pricing unit based on the comparison.

23. The method of claim 22, further comprising the steps of:
step (i): selecting the first price candidate and the second price candidate for serial offering from a pool of untested price candidates;
step (ii): serially calibrating in a serial offering operation the first price candidate and the second price candidate until a corresponding demand measurement for each price candidate has reached a predetermined threshold of demand value before determining a surviving baseline price, wherein the serial offering operation uses a model of demand to represent the demand corresponding to each price candidate and wherein the model of demand reflects a current L2B measurement;
step (iii): determining the surviving baseline price;
step (iv): updating a probability distribution of demand for the surviving baseline price;
step (v): repeating steps (ii), (iii), (iv) until there are no remaining untested price candidates from the pool of untested price candidates by:
using the surviving baseline price as the first price candidate;
selecting any untested price candidate from the pool of untested price candidates as the second price candidate;
selecting the surviving baseline price as a current price for the pricing unit when there are no remaining untested price candidates form the pool of untested price candidates.

24. The method of claim 23, wherein the model of demand comprises using a binomial model of demand.

25. The method of claim 23, wherein the model of demand comprises performing a probabilistic estimation of a L2B ratio based on a Bayesian update of the probability distribution of demand.

26. The method of claim 25, wherein the Bayesian update includes using a Beta distribution to represent both a prior probability distribution of demand and a posterior probability distribution of demand.

27. The method of claim 23, wherein updating the probability distribution of the surviving baseline price comprises periodic resetting of the probability distribution of demand by temporally discounting previous L2B measurements in the probability distribution of demand corresponding to each price candidate.

28. The method of claim 23, wherein updating the probability distribution of the surviving baseline price comprises performing a window averaging of each ordinate value of the probability distribution of demand for the pricing unit corresponding to each price candidate.

29. The method of claim 28, wherein the probability distribution of demand is initially a uniform probability distribution.

30. The method of claim 23, further comprising the steps of:
marking the first price candidate as a first active price candidate;
calibrating the first active price candidate until a first demand measurement (L2B measurement) corresponding to the first active price candidate reaches the predetermined threshold of demand value; and
when the first active price candidate reaches the predetermined threshold of demand value, marking the first active price candidate as a first pending price candidate.

31. The method of claim 30, further comprising the steps of.
after the first active price candidate reaches the predetermined threshold of demand value, selecting the second price candidate for the serial offering operation from the pool of untested price candidates;
marking the second price candidate as a second active price candidate;
calibrating the second active price candidate until a second demand measurement (L2B measurement) corresponding to the second active price candidate reaches the predetermined threshold of demand value; and
when the second active price candidate reaches the predetermined threshold of demand value, marking the second active price candidate as a second pending price candidate.

32. The method of claim 23, further comprising the steps of:
selecting for serial offering until convergence one pending price candidate that is a member of a set of pending price candidates that includes a first pending price candidate and a second pending price candidate;
if the selected pending price candidate reaches convergence, using the selected pending price candidate as a baseline price; and
determining whether a remaining pending price candidate that was not selected for serial offering until convergence from the set of pending price candidates out-performs or under-performs the baseline price.

33. The method of claim 32, further comprising the steps of:
if the remaining pending price candidate that was not selected for serial offering until convergence out-performs the baseline price, then rejecting the baseline price and use the remaining pending price candidate that out-performs the baseline price as the surviving baseline price; and
if the remaining pending price candidate that was not selected for serial offering until convergence under-performs the baseline price, then rejecting the remaining pending price candidate that under-performs the baseline price and use the baseline price as the surviving baseline price.

34. The method of claim 32, further comprising the steps of:
step A: if the selected pending price candidate does not reach convergence, then rejecting the selected pending price candidate;
step B: selecting a new untested price candidate from the pool of untested price candidates;
step C: marking the new untested price candidate as a new active price candidate;
step D: calibrating the new active price candidate until a new demand measurement (L2B measurement) corresponding to the new active price candidate reaches the predetermined threshold of demand value;
step E: when the new active price candidate reaches the predetermined threshold of demand value, marking the new active price candidate as a new pending price candidate; and
step F: selecting for serial offering until convergence one pending price candidate that is a member of a new set of pending price candidates that includes the remaining pending price candidate and the new pending price candidate;
step G: determining whether the selected pending price candidate reaches convergence;
step H: if the selected pending price candidate does not reach convergence, then rejecting the selected pending price candidate and repeating steps B, C, D, E, F, G, H until the selected pending price candidate reaches convergence;
using the selected pending price candidate that reaches convergence as the baseline price; and
determining whether a new remaining pending price candidate that was not selected for serial offering until convergence from the new set of pending price candidates out-performs or under-performs the baseline price;
if the new remaining pending price candidate that was not selected for serial offering until convergence out-performs the baseline price, then rejecting the baseline price and use the new remaining pending price candidate that out-performs the baseline price as the surviving baseline price; and
if the new remaining pending price candidate that was not selected for serial offering until convergence under-performs the baseline price, then rejecting the new remaining pending price candidate that under-performs the baseline price and use the baseline price as the surviving baseline price.

35. The method of claim 22, further comprising the steps of:
monitoring a current price of the pricing unit during a monitor operation to determine whether a most-recent demand measurement (L2B measurement) that is measured during the monitor operation corresponding to the current price is within a predetermined demand interval; and
if the most-recent demand measurement (L2B measurement) is not within the predetermined demand interval, then adjusting the current price to form a new current price so that a new most-recent demand measurement (L2B measurement) corresponding to the new current price is within the predetermined demand interval.

36. The method of claim 35, wherein adjusting the current price comprises automatically changing the current price without re-calibrating any price candidates.

37. The method of claim 35, further comprising the step of:
if the most-recent demand measurement (L2B measurement) is not within the predetermined demand interval and a number of price adjustments to the current price exceeds a user-selected number of price adjustments, then determining a new pool of untested price candidates; and
restarting a serial offering operation using the new pool of untested price candidates.

38. The method of claim 35, wherein the predetermined demand interval is user-selected.

39. The method of claim 35, wherein the predetermined demand interval surrounds a mean demand value corresponding to the current price.

40. A computer-readable medium carrying one or more sequences of instructions for pricing a pricing unit, wherein execution of the one or more sequences of instructions by one or more processors causes the one or more processors to perform the steps of:
during a particular time interval, concurrently offering the pricing unit at a plurality of price candidates;
making one or more L2B measurements for each of the plurality of price candidates for the particular time interval;
performing a comparison between the L2B measurements for the plurality of price candidates; and
determining how to price the pricing unit based on the comparison.

41. The computer-readable medium of claim 40, wherein concurrently offering the pricing unit further comprises the steps of:
selecting the plurality of price candidates for a parallel offering operation from a pool of untested price candidates;
marking the plurality of price candidates as a plurality of active price candidates;
concurrently calibrating all active price candidates of the plurality of price candidates until there are no more active price candidates remaining to be calibrated; and
using in the parallel offering operation a model of demand to represent the demand corresponding to each price candidate, wherein the model of demand reflects a current L2B measurement.

42. The computer-readable medium of claim 41, wherein the model of demand comprises a binomial model of demand.

43. The computer-readable medium of claim 41, wherein the model of demand comprises performing a probabilistic estimation of a L2B ratio based on a Bayesian update of a binomial model of demand.

44. The computer-readable medium of claim 43, wherein the Bayesian update includes using a Beta distribution to represent both a prior probability distribution of demand and a posterior probability distribution of demand.

45. The computer-readable medium of claim 41, wherein the model of demand comprises one or more periodic resettings of a probability distribution of demand by temporally discounting previous L2B measurements in the probability distribution of demand corresponding to each price candidate.

46. The computer-readable medium of claim 45, wherein the one or more periodic resettings of the probability distribution of demand includes performing a window averaging of each ordinate value of a prior probability distribution of demand corresponding to each price candidate.

47. The computer-readable medium of claim 41, wherein the pool of untested price candidates is user-selected.

48. The computer-readable medium of claim 41, wherein selecting the plurality of price candidates for parallel offering is user-defined.

49. The computer-readable medium of claim 41, wherein concurrently offering the plurality of price candidates further comprises the steps of:
using as a baseline price, a first-to-converge active price candidate from the plurality of active price candidates;
marking as a rejected price candidate any active price candidate that is determined as under-performing the baseline price and simultaneously performing the steps of:
if the pool of untested candidates has any remaining untested price candidates then replacing the rejected price candidate with any untested price candidate from the pool of untested price candidates;
marking the untested price candidate that is replacing the rejected price candidate as active for introduction into the plurality of active price candidates for concurrent offering in the parallel offering operation; and
updating a probability distribution of demand corresponding to each active price candidate.

50. The computer-readable medium of claim 49, wherein the first-to-converge price candidate is obtained by using the model of demand that comprises performing a probabilistic estimation of a L2B ratio based on a Bayesian update of the probability distribution of demand.

51. The computer-readable medium of claim 49, wherein updating a probability distribution of demand comprises performing a window averaging of each ordinate value of the probability distribution of demand for the pricing unit corresponding to each price candidate.

52. The computer-readable medium of claim 49, wherein any rejected price candidate is removed from the parallel offering operation.

53. The computer-readable medium of claim 49, further comprising the steps of:
marking as an accepted price candidate any active price candidate that is determined as out-performing the baseline price and immediately replacing the baseline price with the accepted price candidate and simultaneously performing the steps of:
marking the baseline price that was replaced by the accepted price candidate as one of the rejected price candidates;
marking the accepted price candidate that replaced the baseline price as the baseline price;
if the pool of untested candidates has remaining untested candidates then replacing the rejected price candidate with any untested price candidate from the pool of untested price candidates;
marking the untested price candidate that is replacing the rejected price candidate as another active price candidate for introduction into the plurality of active price candidates for concurrent offering; and
updating the probability distribution of demand corresponding to each active price candidate.

54. The computer-readable medium of claim 49, further comprising the steps of:
if the pool of untested candidates has no remaining untested candidates then determining whether there are any remaining active price candidates being concurrently tested; and
if it is determined that there are no remaining active price candidates, then marking the baseline price as a current price for the pricing unit.

55. The computer-readable medium of claim 40, further comprising the steps of:
monitoring a current price of the pricing unit during a monitor operation to determine whether a most-recent demand measurement (L2B measurement) that is measured during the monitor operation corresponding to the current price is within a predetermined demand interval; and
if the most-recent demand measurement (L2B measurement) is not within the predetermined demand interval, then adjusting the current price to form a new current price so that a new most-recent demand measurement (L2B measurement) corresponding to the new current price is within the predetermined demand interval.

56. The computer-readable medium of claim 55, wherein adjusting the current price comprises automatically changing the current price without re-calibrating any price candidates.

57. The computer-readable medium of claim 55, further comprising the step of:
if the most-recent demand measurement (L2B measurement) is not within the predetermined demand interval and a number of price adjustments to the current price exceeds a user-selected number of price adjustments, then determining a new pool of untested price candidates; and
restarting a parallel offering operation using the new pool of untested price candidates.

58. The computer-readable medium of claim 55, wherein the predetermined demand interval is user-selected.

59. The computer-readable medium of claim 55, wherein the predetermined demand interval surrounds a mean demand value corresponding to the current price.

60. The computer-readable medium of claim 49 further comprising restarting the parallel offering operation using a new pool of untested price candidates when no baseline price emerges from the parallel offering operation.

61. A computer-readable medium carrying one or more sequences of instructions for pricing a pricing unit, wherein execution of the one or more sequences of instructions by one or more processors causes the one or more processors to perform the steps of:
during a series of time intervals, alternating between offering the pricing unit at a plurality of price candidates;
wherein the pricing unit is offered at a first price candidate during at least a first time interval and a third time interval, and the pricing unit is offered at a second price candidate during at least a second time interval that occurs after the first time interval and before the third time interval;
making one or more demand measurements (L2B measurements) for each of the plurality of price candidates based on sales of the pricing unit during the series of time intervals;
performing a comparison between the demand measurements (L2B measurements) for the plurality of price candidates; and
determining how to price the pricing unit based on the comparison.

62. The computer-readable medium of claim 61, further comprising the steps of:
step (i): selecting the first price candidate and the second price candidate for serial offering from a pool of untested price candidates;
step (ii): serially calibrating in a serial offering operation the first price candidate and the second price candidate until a corresponding demand measurement for each price candidate has reached a predetermined threshold of demand value before determining a surviving baseline price, wherein the serial offering operation uses a model of demand to represent the demand corresponding to each price candidate and wherein the model of demand reflects a current L2B measurement;
step (iii): determining the surviving baseline price;
step (iv): updating a probability distribution of demand for the surviving baseline price;
step (v): repeating steps (ii), (iii), (iv) until there are no remaining untested price candidates from the pool of untested price candidates by:
using the surviving baseline price as the first price candidate;
selecting any untested price candidate from the pool of untested price candidates as the second price candidate;
selecting the surviving baseline price as a current price for the pricing unit when there are no remaining untested price candidates form the pool of untested price candidates.

63. The computer-readable medium of claim 62, wherein the model of demand comprises using a binomial model of demand.

64. The computer-readable medium of claim 62, wherein the model of demand comprises performing a probabilistic estimation of a L2B ratio based on a Bayesian update of the probability distribution of demand.

65. The computer-readable medium of claim 64, wherein the Bayesian update includes using a Beta distribution to represent both a prior probability distribution of demand and a posterior probability distribution of demand.

66. The computer-readable medium of claim 62, wherein updating the probability distribution of the surviving baseline price comprises periodic resetting of the probability distribution of demand by temporally discounting previous L2B measurements in the probability distribution of demand corresponding to each price candidate.

67. The computer-readable medium of claim 62, wherein updating the probability distribution of the surviving baseline price comprises performing a window averaging of each ordinate value of the probability distribution of demand for the pricing unit corresponding to each price candidate.

68. The computer-readable medium of claim 67, wherein the probability distribution of demand is initially a uniform probability distribution.

69. The computer-readable medium of claim 62, further comprising the steps of:
marking the first price candidate as a first active price candidate;
calibrating the first active price candidate until a first demand measurement (L2B measurement) corresponding to the first active price candidate reaches the predetermined threshold of demand value; and
when the first active price candidate reaches the predetermined threshold of demand value, marking the first active price candidate as a first pending price candidate.

70. The computer-readable medium of claim 69, further comprising the steps of:
after the first active price candidate reaches the predetermined threshold of demand value, selecting the second price candidate for the serial offering operation from the pool of untested price candidates;
marking the second price candidate as a second active price candidate;
calibrating the second active price candidate until a second demand measurement (L2B measurement) corresponding to the second active price candidate reaches the predetermined threshold of demand value; and
when the second active price candidate reaches the predetermined threshold of demand value, marking the second active price candidate as a second pending price candidate.

71. The computer-readable medium of claim 62, further comprising the steps of:
selecting for serial offering until convergence one pending price candidate that is a member of a set of pending price candidates that includes a first pending price candidate and a second pending price candidate;
if the selected pending price candidate reaches convergence, using the selected pending price candidate as a baseline price; and
determining whether a remaining pending price candidate that was not selected for serial offering until convergence from the set of pending price candidates out-performs or under-performs the baseline price.

72. The computer-readable medium of claim 71, further comprising the steps of:
if the remaining pending price candidate that was not selected for serial offering until convergence out-performs the baseline price, then rejecting the baseline price and use the remaining pending price candidate that out-performs the baseline price as the surviving baseline price; and
if the remaining pending price candidate that was not selected for serial offering until convergence under-performs the baseline price, then rejecting the remaining pending price candidate that under-performs the baseline price and use the baseline price as the surviving baseline price.

73. The computer-readable medium of claim 71, further comprising the steps of:
step A: if the selected pending price candidate does not reach convergence, then rejecting the selected pending price candidate;
step B: selecting a new untested price candidate from the pool of untested price candidates;
step C: marking the new untested price candidate as a new active price candidate;
step D: calibrating the new active price candidate until a new demand measurement (L2B measurement) corresponding to the new active price candidate reaches the predetermined threshold of demand value;
step E: when the new active price candidate reaches the predetermined threshold of demand value, marking the new active price candidate as a new pending price candidate; and
step F: selecting for serial offering until convergence one pending price candidate that is a member of a new set of pending price candidates that includes the remaining pending price candidate and the new pending price candidate;
step G: determining whether the selected pending price candidate reaches convergence;
step H: if the selected pending price candidate does not reach convergence, then rejecting the selected pending price candidate and repeating steps B, C, D, E, F, G, H until the selected pending price candidate reaches convergence;
using the selected pending price candidate that reaches convergence as the baseline price; and
determining whether a new remaining pending price candidate that was not selected for serial offering until convergence from the new set of pending price candidates out-performs or under-performs the baseline price;
if the new remaining pending price candidate that was not selected for serial offering until convergence out-performs the baseline price, then rejecting the baseline price and use the new remaining pending price candidate that out-performs the baseline price as the surviving baseline price; and
if the new remaining pending price candidate that was not selected for serial offering until convergence under-performs the baseline price, then rejecting the new remaining pending price candidate that under-performs the baseline price and use the baseline price as the surviving baseline price.

74. The computer-readable medium of claim 61, further comprising the steps of:
monitoring a current price of the pricing unit during a monitor operation to determine whether a most-recent demand measurement (L2B measurement) that is measured during the monitor operation corresponding to the current price is within a predetermined demand interval; and
if the most-recent demand measurement (L2B measurement) is not within the predetermined demand interval, then adjusting the current price to form a new current price so that a new most-recent demand measurement (L2B measurement) corresponding to the new current price is within the predetermined demand interval.

75. The computer-readable medium of claim 74, wherein adjusting the current price comprises automatically changing the current price without re-calibrating any price candidates.

76. The computer-readable medium of claim 74, further comprising the step of:
if the most-recent demand measurement (L2B measurement) is not within the predetermined demand interval and a number of price adjustments to the current price exceeds a user-selected number of price adjustments, then determining a new pool of untested price candidates; and
restarting a serial offering operation using the new pool of untested price candidates.

77. The computer-readable medium of claim 74, wherein the predetermined demand interval is user-selected.

78. The computer-readable medium of claim 74, wherein the predetermined demand interval surrounds a mean demand value corresponding to the current price.
